(19) United States
(12) Patent Application Publication
(10) Pub. No.: US 2026/0317523 A1
(43) Pub. Date: Oct. 15, 2026

(54) POLYMER COMPOSITION

(71) Applicant: BOREALIS GMBH, Vienna (AT)

(72) Inventors: Qizheng Dou, Linz (AT); Minna Aarnio-Winterhof, Linz (AT); Francis Costa, Linz (AT); Dietrich Gloger, Linz (AT); Jeroen Oderkerk, Stenungsund (SE); Jessica Hesselgren, Stenungsund (SE)

(21) Appl. No.: 19/485,708

(22) PCT Filed: Apr. 26, 2024
(86) PCT No.: PCT/EP2024/061510

§ 371 Date: Nov. 19, 2025

(30) Foreign Application Priority Data
May 24, 2023 (EP) 23175058.9

(51) Int. Cl. C08L 23/14

(52) U.S. Cl. CPC C08L 23/142; C08L 2203/162; C08L 2205/025; C08L 2205/03; C08L 2207/02; C08L 2207/062

(57) ABSTRACT

The present invention discloses a polymer composition (C) comprising: a) a heterophasic propylene-ethylene copolymer (HECO) having a melt flow rate (MFR2) as determined at 230° C. under a load of 2.16 kg in accordance with ISO 1133 of from 0.1 to 15.0 g/10 min, in an amount of from 50 to 99 wt.-% based on the total weight of the polymer composition (C), comprising: a1) a crystalline matrix that is a propylene homopolymer or a copolymer of propylene and ethylene and/or C3-C12 alpha olefins; a2) an amorphous propylene-ethylene elastomer (EPR); wherein the heterophasic propylene-ethylene copolymer (HECO) is further characterized by its crystalline fraction (CF) and soluble fraction (SF) as determined by CRYSTEX QC analysis, wherein the soluble fraction (SF) has an ethylene content of from 10 to 50 wt.-% based on the total weight of the soluble fraction (SF; b) a propylene homopolymer (PP-H) having a melt flow rate (MFR2) as determined at 230° C. under a load of 2.16 kg in accordance with ISO 1133 of from 0.01 to 5.0 g/10 min, in an amount of from 1 to 30 wt.-% based on the total weight of the polymer composition (C); and c) optionally, a high density polyethylene (HDPE) with a density of from 940 to 985 kg/m3, in an amount of from 0 to 20 wt.-% based on the total weight of the polymer composition (C).

### FIELD OF THE INVENTION

The present invention pertains to a polymer composition (C) comprising a heterophasic propylene-ethylene copolymer (HECO), a propylene homopolymer (PP-H) and preferably a high-density polyethylene (HDPE). The present invention further pertains to an article, preferably a film, comprising such a polymer composition and use of such article in packaging applications.

### BACKGROUND OF THE INVENTION

Heterophasic propylene compositions, which are widely used for packaging products comprising two phases: a matrix phase, which can be a homopolymer or copolymer of propylene and a dispersed phase (so-called elastomeric phase) that is an ethylene-propylene rubber. With a proper design of these phases (considering parameters such as selection of matrix, type and/or amount of monomers or comonomers, molecular weight, intrinsic viscosity and so on), the desired properties of such compositions can be obtained.

In general, heterophasic propylene compositions are known to be high-impact materials over a wide range of temperatures. The improved impact behavior is mainly attributed to the presence of the dispersed phase, compensating the brittle behavior of homopolymer or copolymers of propylene due to their crystallinity. However, a major disadvantage of the dispersed phase then becomes stiffness that is lowered due to interruption of crystallinity. In other words, the same dispersed phase may be responsible for an improved impact behavior and lowered stiffness, if not designed properly. Another major disadvantage of having a multiple-phase system is optical properties that are not ideal. The presence of a matrix phase and a dispersed phase may cause the light being scattered at the interface between matrix and dispersed phase, causing more hazy appearance of the article made of such heterophasic propylene composition.

WO 2018/077663 A1 discloses a heterophasic propylene composition with a melt flow rate MFR₂ of at most 6.0 g/10 min, comprising propylene homopolymer in an amount of higher than or equal to 80 wt.-%, an elastomeric ethylene-propylene rubber fraction in an amount of less than 20 wt.-%, a polymeric nucleating agent and at least one further nucleating or clarifying agent. Despite focusing on improving optical properties, WO 2018/077663 A1 focuses on solving this problem with the use of nucleating agents.

WO 2007/071447 A1 discloses a polyolefin composition containing at least 80 wt.-% of a heterophasic propylene copolymer, a polymeric nucleating agent and up to 20 wt.-% of low-density polyethylene. Even though WO 2007/071447 A1 aims to improve optical properties along with mechanical properties, it proposes the use of polymeric nucleating agent and the low-density polyethylene for that purpose.

Therefore, there is a constant need for polymer compositions comprising heterophasic propylene compositions with a balance of improved stiffness, impact behavior and optical properties. The present invention relates to a polymer composition that meets the mentioned requirements.

### SUMMARY OF THE INVENTION

The present invention relates to a polymer composition (C) comprising:
a) a heterophasic propylene-ethylene copolymer (HECO) having a melt flow rate (MFR₂) as determined at 230° C. under a load of 2.16 kg in accordance with ISO 1133 of from 0.1 to 15.0 g/10 min, in an amount of from 50 to 99 wt.-% based on the total weight of the polymer composition (C), comprising:
a1) a crystalline matrix that is a propylene homopolymer or a copolymer of propylene and ethylene and/or C₃-C₁₂ alpha olefins;
a2) an amorphous propylene-ethylene elastomer (EPR);
wherein the heterophasic propylene-ethylene copolymer (HECO) is further characterized by its crystalline fraction (CF) and soluble fraction (SF) as determined by CRYSTEX QC analysis, wherein the soluble fraction (SF) has an ethylene content of from 10 to 50 wt.-% based on the total weight of the soluble fraction (SF;
b) a propylene homopolymer (PP-H) having a melt flow rate (MFR₂) as determined at 230° C. under a load of 2.16 kg in accordance with ISO 1133 of from 0.01 to 5.0 g/10 min, in an amount of from 1 to 30 wt.-% based on the total weight of the polymer composition (C); and
c) optionally, a high density polyethylene (HDPE) with a density of from 940 to 985 kg/m³, in an amount of from 0 to 20 wt.-% based on the total weight of the polymer composition (C).

The present invention further relates to an article, preferably a film, comprising the polymer composition (C) as described herein.

The present invention further relates to use of the article, more preferably the film as disclosed herein in packaging applications.

### DETAILED DESCRIPTION

A “propylene homopolymer” as used herein indicates a polymer that mainly consists of monomer units of propylene and comprises up to 0.1 mol-% comonomer units.

A “propylene copolymer” as used herein indicates a polymer that comprises monomer units of propylene and comonomer units. When the comonomers of the polymer are distributed randomly along the polymer chain, the propylene copolymer is called as “random” and when the comonomers of the polymer are distributed as blocks along the chain, the propylene copolymer is called as “block”.

“Heterophasic propylene-ethylene copolymer (HECO)” as used herein indicates polymer compositions comprising two phases: a crystalline phase that is a propylene homopolymer or copolymer of propylene and ethylene and/or another comonomer, and an amorphous phase that is an elastomeric rubber (usually ethylene-propylene rubber, EPR).

A “unimodal polymer” as used herein refers to a polymer having a single fraction, usually produced in a single-reactor system. When a polymer contains multiple fractions differing from each other by at least one property, such as molecular weight, it is called as “multimodal” (bimodal, if there are two fractions present).

### Polymer Composition (C)

The polymer composition (C) according to the present invention comprises a heterophasic propylene-ethylene copolymer (HECO) in an amount of from 50 to 99 wt.-%, a propylene homopolymer (PP-H) in an amount of from 1 to 30 wt.-%, and optionally a high density polyethylene (HDPE) in an amount of from 0 to 20 wt.-%, based on the total weight of the polymer composition (C).

It is preferred that the polymer composition (C) has at least one or more, preferably all of the following properties:
a tensile modulus in machine direction, measured on 400 μm cast film in accordance with ISO 527-3, of from 200 to 1000 MPa, more preferably from 400 to 950 MPa,
a tensile modulus in transverse direction, measured on 400 μm cast film in accordance with ISO 527-3, of from 200 to 1000 MPa, more preferably from 400 to 850 MPa,
a haze, measured on 400 μm cast film in accordance with ASTM D1003-00, of from 5 to 40%, more preferably from 10 to 30%.

In other words, while the polymer composition (C) may preferably have at least one or more of the properties as listed above, it is the most preferred when it has all the mentioned properties.

It is also preferred that the polymer composition (C) has at least one or more, preferably all of the following properties:
a Charpy Notched Impact Strength (NIS), measured on 80×10×4 mm specimens at 23° C. in accordance with ISO 179 1eA, of from 15 to 70 kJ/m², more preferably from 20 to 50 kJ/m²,
a Charpy Notched Impact Strength (NIS), measured on 80×10×4 mm specimens at 0° C. in accordance with ISO 179 1eA, of from 1 to 10 kJ/m²,
an elongation at break in machine direction, measured on 400 μm cast film at 0° C. in accordance with ISO 527-3, of from 200 to 900%, more preferably from 300 to 750%,
an elongation at break in transverse direction, measured on 400 μm cast film at 0° C. in accordance with ISO 527-3, of from 200 to 850%, more preferably from 300 to 800%.

In other words, while the polymer composition (C) may preferably have at least one or more of the properties as listed above, it is the most preferred when it has all the mentioned properties.

### Heterophasic Propylene-Ethylene Copolymer (HECO)

The heterophasic propylene-ethylene copolymer (HECO) according to the present invention comprises a crystalline matrix that is a propylene homopolymer or a copolymer of propylene and ethylene and/or C₃-C₁₂ alpha olefins; and an amorphous propylene-ethylene elastomer (EPR).

Crystalline matrix is preferably a homopolymer of propylene, preferably with a melt flow rate (MFR₂) as determined at 230° C. under a load of 2.16 kg in accordance with ISO 1133 of from 0.5 to 10.0 g/10 min, more preferably of from 1.0 to 3.5 g/10 min.

It is preferred that the heterophasic propylene-ethylene copolymer (HECO) is in an amount of from 60 to 90 wt.-%, based on the total weight of the polymer composition (C).

The heterophasic propylene-ethylene copolymer (HECO) has a melt flow rate (MFR₂) as determined at 230° C. under a load of 2.16 kg in accordance with ISO 1133 of from 0.1 to 15.0 g/10 min. It is preferred that the melt flow rate (MFR₂) as determined at 230° C. under a load of 2.16 kg in accordance with ISO 1133 ranges from 0.5 to 10.0 g/10 min, more preferably from 1.0 to 7.0 g/10 min.

The heterophasic propylene-ethylene copolymer (HECO) is further characterized by its crystalline fraction (CF) and soluble fraction (SF) as determined by CRYSTEX QC analysis, wherein the soluble fraction (SF) has an ethylene content of from 10 to 50 wt.-% based on the weight of the soluble fraction (SF).

The heterophasic propylene-ethylene copolymer (HECO) preferably has at least one or more, preferably all of the following properties according to CRYSTEX QC analysis:
a crystalline fraction (CF) in an amount of from 70 to 95 wt.-% and a soluble fraction (SF) in an amount from 5 to 30 wt.-%, based on the total weight of the heterophasic propylene-ethylene copolymer (HECO),
a total ethylene (C2) content of from 0.5 to 25 wt.-%, more preferably from 1 to 15 wt.-%,
an ethylene (C2) content of crystalline fraction (CF) of from 0.5 to 25 wt.-%, more preferably from 1 to 20 wt.-%,
an ethylene (C2) content of soluble fraction (SF) of from 20 to 40 wt.-%, more preferably from 25 to 35 wt.-%,
an intrinsic viscosity (IV) of crystalline fraction (CF), determined in accordance with DIN ISO 1628/1 (in Decalin 135° C.), of from 1.0 to 10.0 dL/g, more preferably of from 1.5 to 5.0 dL/g,
an intrinsic viscosity (IV) of soluble fraction (SF), determined in accordance with DIN ISO 1628/1 (in Decalin 135° C.), of from 0.5 to 10.0 dL/g, more preferably of from 1.0 to 5.0 dL/g.

In other words, while the heterophasic propylene-ethylene copolymer (HECO) may preferably have at least one or more properties according to CRYSTEX QC given above, it is the most preferred when it has all of the mentioned properties.

### Process for HECO

The heterophasic propylene-ethylene copolymer (HECO) may be produced in a multistage polymerization process, comprising the steps of:
a) preparing the crystalline matrix that is a propylene homopolymer or a copolymer of propylene and ethylene and/or C3-C12 alpha-olefins by
   a1) polymerizing in a first reactor propylene to obtain a first propylene polymer fraction,
   a2) transferring the first propylene polymer fraction to a second reactor, and polymerizing in the second reactor propylene to obtain a second propylene polymer fraction,
b) preparing a disperse phase of the heterophasic propylene copolymer by
   b1) transferring the first propylene polymer fraction and the second propylene polymer fraction to a third reactor, and polymerizing in the third reactor propylene and ethylene, to obtain a third propylene polymer fraction,
wherein polymerizing in steps a1), a2) and b1) is conducted in the presence of a Ziegler-Natta catalyst system as described below.

The first reactor is preferably a slurry phase reactor, such as a loop reactor. It is preferred that the operating temperature in the first reactor, preferably the loop reactor, is in the range from 62 to 95° C., more preferably in the range from 65 to 90° C., still more preferably in the range from 70 to 85° C.

Typically, the pressure in the first reactor, preferably in the loop reactor, is in the range from 20 to 80 bar, preferably 30 to 70 bar, like 35 to 65 bar.

It is preferred that in the first reactor, preferably the loop reactor, a propylene homopolymer is produced. Thus, it is preferred that the first propylene polymer fraction is a propylene homopolymer fraction.

Preferably hydrogen is added in the first reactor in order to control the molecular weight, i.e. the melt flow rate MFR₂. Preferably, in step a1) a ratio of the feed of hydrogen to the feed of propylene is 0.10 to 0.6 mol/kmol, more preferably 0.15 to 0.50 mol/kmol, and most preferably 0.20 to 0.45 mol/kmol.

The average residence time in the first reactor, preferably the loop reactor, is typically from 15 to 120 min, preferably from 20 to 80 min. As it is well known in the art the average residence time τ can be calculated from equation (1) below:

$$τ = \frac{{V}_{R}}{{Q}_{o}} \qquad equation ( 1 )$$

wherein
V_{R} is the volume of the reaction space (in case of a loop reactor, the volume of the reactor, in case of the fluidized bed reactor, the volume of the fluidized bed)
Qₒ is the volumetric flow rate of the product stream (including the polymer product and the fluid reaction mixture).

The production rate is suitably controlled by the catalyst feed rate and temperature. It is also possible to influence the production rate by suitable selection of the monomer concentration. The desired monomer concentration can then be achieved by suitably adjusting the propylene feed rate.

The second reactor preferably is a first gas phase reactor, such as a first fluidized bed gas phase reactor. It is preferred that the operating temperature in the second reactor, preferably the first gas phase reactor, is in the range from 65 to 95° C., more preferably in the range from 70 to 85° C. Preferably, the pressure in the second reactor, preferably in the first gas phase reactor, is in the range from 5 to 50 bar, preferably 15 to 40 bar.

The average residence time in the second reactor, preferably the first gas phase reactor, is typically 30 to 130 min. Reference is made to equation (1) above.

It is preferred that in the second reactor, preferably the first gas phase reactor, a propylene homopolymer is produced. Thus, it is preferred that the second propylene polymer fraction is a propylene homopolymer fraction.

Preferably hydrogen is added in the second reactor in order to control the molecular weight, i.e. the melt flow rate MFR₂. Preferably the hydrogen to propylene ratio (H2/C3 ratio) in the second reactor, preferably the first gas phase reactor, is in the range from 2.0 to 9.0 mol/kmol, more preferably 4.0 to 8.0 mol/kmol.

The third reactor preferably is a second gas phase reactor, such as a second fluidized bed gas phase reactor. It is preferred that the operating temperature in the third reactor, preferably the second gas phase reactor, is in the range from 65 to 85° C., more preferably in the range from 68 to 82° C. Typically, the operating temperature in third reactor is lower than the operating temperature in the second reactor. Typically, the pressure in the third reactor, preferably in the second gas phase reactor, is in the range from 5 to 50 bar, preferably 15 to 40 bar.

The average residence time in the third reactor, preferably the second gas phase reactor, is typically 30 to 130 min. Reference is made to equation (1) above.

In the third reactor, preferably the second gas phase reactor, the disperse phase of the heterophasic propylene copolymer is produced, i.e. a copolymer of propylene and ethylene.

The ethylene to propylene ratio (C2/C3 ratio) in the third reactor, preferably the second gas phase reactor, is in the range from 300 to 1000 mol/kmol, more preferably 400 to 800 mol/kmol.

A preferred multistage process is the above-identified slurry-gas phase process, such as developed by Borealis and known as the Borstar® technology. In this respect, reference is made to the EP applications EP 0 887 379 A1 and EP 0 517 868 A1.

In the process for producing the heterophasic propylene-ethylene copolymer (HECO), there may be a pre-polymerization conducted prior to the first polymerization step a).

In the pre-polymerization reactor, a polypropylene is produced. The pre-polymerization is conducted in the presence of the Ziegler-Natta catalyst system. However, this shall not exclude the option that at a later stage for instance further cocatalyst is added in the polymerization process, for instance in the first reactor. The pre-polymerization reaction is typically conducted at a temperature of 0 to 60° C., preferably from 15 to 50° C., and more preferably from 20 to 45° C. The pressure in the pre-polymerization reactor is not critical but must be sufficiently high to maintain the reaction mixture in liquid phase. Thus, the pressure may be from 20 to 100 bar, for example 30 to 70 bar. The average residence time in the pre-polymerization reactor is typically 15 to 45 min. Reference is made to equation (1) above.

In a preferred embodiment, the pre-polymerization is conducted as bulk slurry polymerization in liquid propylene, i.e. the liquid phase mainly comprises propylene, with optionally inert components dissolved therein.

It is possible to add other components also to the pre-polymerization stage. Thus, hydrogen may be added into the pre-polymerization stage to control the molecular weight of the polypropylene as is known in the art.

As mentioned above, if a pre-polymerization is used, subsequent to said pre-polymerization, the mixture of the Ziegler-Natta catalyst system and the polypropylene produced in the pre-polymerization reactor is transferred to the first reactor. Typically the total amount of the polypropylene produced in the pre-polymerization reactor in the first, second and third propylene polymer fractions is rather low and typically not more than 5.0 wt.-%, more preferably not more than 4.0 wt.-%, still more preferably in the range from 0.1 to 4.0 wt.-%, like in the range 0.5 of to 3.0 wt.-%.

### Catalyst for HECO

The catalyst used for the production of heterophasic propylene-ethylene copolymer (HECO) may be a solid Ziegler-Natta catalyst (ZN-C), which comprises compounds (TC) of a transition metal of Group 4 to 6 of IUPAC, like titanium, a Group 2 metal compound (MC), like a magnesium, and an internal donor (ID) being a non-phthalic compound, preferably a non-phthalic acid ester, still more preferably being a diester of non-phthalic dicarboxylic acids as described in more detail below. Thus, the catalyst is in a preferred embodiment fully free of undesired phthalic compounds. Further, the solid catalyst is free of any external support material, like silica or MgCl₂, but the catalyst is self-supported.

The Ziegler-Natta catalyst can be further defined by the way as obtained. Accordingly, the Ziegler-Natta catalyst is preferably obtained by a process comprising the steps of
a)
a₁) providing a solution of at least a Group 2 metal alkoxy compound (Ax) being the reaction product of a Group 2 metal compound (MC) and a monohydric alcohol (A) comprising in addition to the hydroxyl moiety at least one ether moiety optionally in an organic liquid reaction medium; or
a₂) a solution of at least a Group 2 metal alkoxy compound (Ax′) being the reaction product of a Group 2 metal compound (MC) and an alcohol mixture of the monohydric alcohol (A) and a monohydric alcohol (B) of formula ROH, optionally in an organic liquid reaction medium; or
a₃) providing a solution of a mixture of the Group 2 alkoxy compound (Ax) and a Group 2 metal alkoxy compound (Bx) being the reaction product of a Group 2 metal compound (MC) and the monohydric alcohol (B), optionally in an organic liquid reaction medium; or
a₄) providing a solution of Group 2 alkoxide of formula M(OR₁)ₙ(OR₂)ₘX₂₋ₙ₋ₘ or mixture of Group 2 alkoxides M(OR₁)_{n′}X_{2-n′} and M(OR₂)_{m′}X_{2-m′}, where M is Group 2 metal, X is halogen, R₁ and R₂ are different alkyl groups of C₂ to C₁₆ carbon atoms, and 0≤n<2, 0≤m<2 and n+m+(2−n−m)=2, provided that both n and m≠0, 0<n′≤2 and 0<m′≤2; and
b) adding said solution from step a) to at least one compound (TC) of a transition metal of Group 4 to 6 and
c) obtaining the solid catalyst component particles,
   and adding an internal electron donor (ID), preferably a non-phthalic internal donor (ID), at any step prior to step c).

The internal donor (ID) or precursor thereof is thus added preferably to the solution of step a) or to the transition metal compound before adding the solution of step a).

According to the procedure above the Ziegler-Natta catalyst (ZN-C) can be obtained via precipitation method or via emulsion—solidification method depending on the physical conditions, especially temperature used in steps b) and c). Emulsion is also called in this application liquid/liquid two-phase system. In both methods (precipitation or emulsion-solidification) the catalyst chemistry is the same.

In precipitation method combination of the solution of step a) with at least one transition metal compound (TC) in step b) is carried out and the whole reaction mixture is kept at least at 50° C., more preferably in the temperature range of 55 to 110° C., more preferably in the range of 70 to 100° C., to secure full precipitation of the catalyst component in form of a solid particles (step c).

In emulsion—solidification method in step b) the solution of step a) is typically added to the at least one transition metal compound (TC) at a lower temperature, such as from −10 to below 50° C., preferably from −5 to 30° C. During agitation of the emulsion the temperature is typically kept at −10 to below 40° C., preferably from −5 to 30° C. Droplets of the dispersed phase of the emulsion form the active catalyst composition. Solidification (step c) of the droplets is suitably carried out by heating the emulsion to a temperature of 70 to 150° C., preferably to 80 to 110° C.

The catalyst prepared by emulsion-solidification method is preferably used in the present invention.

In a preferred embodiment in step a) the solution of a₂) or a₃) are used, i.e. a solution of (Ax′) or a solution of a mixture of (Ax) and (Bx), especially the solution of a₂).

Preferably the Group 2 metal (MC) is magnesium.

The magnesium alkoxy compounds as defined above can be prepared in situ in the first step of the catalyst preparation process, step a), by reacting the magnesium compound with the alcohol(s) as described above, or said magnesium alkoxy compounds can be separately prepared magnesium alkoxy compounds or they can be even commercially available as ready magnesium alkoxy compounds and used as such in the catalyst preparation process of the invention.

Illustrative examples of alcohols (A) are glycol monoethers. Preferred alcohols (A) are C₂ to C₄ glycol monoethers, wherein the ether moieties comprise from 2 to 18 carbon atoms, preferably from 4 to 12 carbon atoms. Preferred examples are 2-(2-ethylhexyloxy)ethanol, 2-butyloxy ethanol, 2-hexyloxy ethanol and 1,3-propylene-glycol-monobutyl ether, 3-butoxy-2-propanol, with 2-(2-ethylhexyloxy)ethanol and 1,3-propylene-glycol-monobutyl ether, 3-butoxy-2-propanol being particularly preferred.

Illustrative monohydric alcohols (B) are of formula ROH, with R being straight-chain or branched C₂-C₁₆ alkyl residue, preferably C₄ to C₁₀, more preferably C₆ to C₈ alkyl residue. The most preferred monohydric alcohol is 2-ethyl-1-hexanol or octanol.

Preferably a mixture of Mg alkoxy compounds (Ax) and (Bx) or mixture of alcohols (A) and (B), respectively, are used and employed in a mole ratio of Bx:Ax or B:A from 10:1 to 1:10, more preferably 6:1 to 1:6, most preferably 4.1 to 1:4.

Magnesium alkoxy compound may be a reaction product of alcohol(s), as defined above, and a magnesium compound selected from dialkyl magnesium, alkyl magnesium alkoxides, magnesium dialkoxides, alkoxy magnesium halides and alkyl magnesium halides. Further, magnesium dialkoxides, magnesium diaryloxides, magnesium aryloxyhalides, magnesium aryloxides and magnesium alkyl aryloxides can be used. Alkyl groups can be a similar or different C₁-C₂₀ alkyl, preferably C₂-C₁₀ alkyl. Typical alkyl-alkoxy magnesium compounds, when used, are ethyl magnesium butoxide, butyl magnesium pentoxide, octyl magnesium butoxide and octyl magnesium octoxide. Preferably the dialkyl magnesium are used. Most preferred dialkyl magnesium are butyl octyl magnesium or butyl ethyl magnesium.

It is also possible that magnesium compound can react in addition to the alcohol (A) and alcohol (B) also with a polyhydric alcohol (C) of formula R″ (OH)ₘ to obtain said magnesium alkoxide compounds. Preferred polyhydric alcohols, if used, are alcohols, wherein R″ is a straight-chain, cyclic or branched C₂ to C₁₀ hydrocarbon residue, and m is an integer of 2 to 6.

The magnesium alkoxy compounds of step a) are thus selected from the group consisting of magnesium dialkoxides, diaryloxy magnesium, alkyloxy magnesium halides, aryloxy magnesium halides, alkyl magnesium alkoxides, aryl magnesium alkoxides and alkyl magnesium aryloxides. In addition a mixture of magnesium dihalide and a magnesium dialkoxide can be used.

The solvents to be employed for the preparation of the present catalyst may be selected among aromatic and aliphatic straight chain, branched and cyclic hydrocarbons with 5 to 20 carbon atoms, more preferably 5 to 12 carbon atoms, or mixtures thereof. Suitable solvents include benzene, toluene, cumene, xylene, pentane, hexane, heptane, octane and nonane. Hexanes and pentanes are particular preferred.

The reaction for the preparation of the magnesium alkoxy compound may be carried out at a temperature of 40° C. to 70° C. Most suitable temperature is selected depending on the Mg compound and alcohol(s) used.

The transition metal compound of Group 4 to 6 is preferably a titanium compound, most preferably a titanium halide, like TiCl₄.

The internal donor (ID) used in the preparation of the catalyst used in the present invention is preferably selected from (di)esters of non-phthalic carboxylic (di)acids, 1,3-diethers, derivatives and mixtures thereof. Especially preferred donors are diesters of mono-unsaturated dicarboxylic acids, in particular esters belonging to a group comprising malonates, maleates, succinates, citraconates, glutarates, cyclohexene-1,2-dicarboxylates and benzoates, and any derivatives and/or mixtures thereof. Preferred examples are e.g, substituted maleates and citraconates, most preferably citraconates.

In emulsion method, the two phase liquid-liquid system may be formed by simple stirring and optionally adding (further) solvent(s) and additives, such as the turbulence minimizing agent (TMA) and/or the emulsifying agents and/or emulsion stabilisers, like surfactants, which are used in a manner known in the art for facilitating the formation of and/or stabilise the emulsion. Preferably, surfactants are acrylic or methacrylic polymers. Particular preferred are unbranched C₁₂ to C₂₀ (meth)acrylates such as poly(hexadecyl)-methacrylate and poly(octadecyl)-methacrylate and mixtures thereof. Turbulence minimizing agent (TMA), if used, is preferably selected from α-olefin polymers of α-olefin monomers with 6 to 20 carbon atoms, like polyoctene, polynonene, polydecene, polyundecene or polydodecene or mixtures thereof. Most preferable it is polydecene.

The solid particulate product obtained by precipitation or emulsion—solidification method may be washed at least once, preferably at least twice, most preferably at least three times with an aromatic and/or aliphatic hydrocarbons, preferably with toluene, heptane or pentane and or with TiCl₄. Washing solutions can also contain donors and/or compounds of Group 13, like trialkyl aluminum, halogenated alky aluminum compounds or alkoxy aluminum compounds. Aluminum compounds can also be added during the catalyst synthesis. The catalyst can further be dried, as by evaporation or flushing with nitrogen, or it can be slurried to an oily liquid without any drying step.

The finally obtained Ziegler-Natta catalyst is desirably in the form of particles having generally an average particle size range of 5 to 200 μm, preferably 10 to 100 μm. Particles are compact with low porosity and have surface area below 20 g/m², more preferably below 10 g/m². Typically, the amount of Ti is 1 to 6 wt.-%, Mg 10 to 20 wt.-% and donor 10 to 40 wt.-% of the catalyst composition.

Detailed description of preparation of catalysts is disclosed in WO 2012/007430, EP2610271, EP 2610270 and EP2610272.

The Ziegler-Natta catalyst (ZN-C) is preferably used in association with an alkyl aluminum cocatalyst and optionally external donors.

As further component in the instant polymerization process an external donor (ED) is preferably present. Suitable external donors (ED) include certain silanes, ethers, esters, amines, ketones, heterocyclic compounds and blends of these. It is especially preferred to use a silane. It is most preferred to use silanes of the general formula

R^{a}ₚR^{b}_{q}Si(OR^{c})_{(4-p-q)}

wherein R^{a}, R^{b} and R^{c} denote a hydrocarbon radical, in particular an alkyl or cycloalkyl group, and wherein p and q are numbers ranging from 0 to 3 with their sum p+q being equal to or less than 3. R^{a}, R^{b} and R^{c} can be chosen independently from one another and can be the same or different. Specific examples of such silanes are (tert-butyl)₂Si(OCH₃) 2, (cyclohexyl)(methyl)Si(OCH₃)², (phenyl)₂Si(OCH₃)² and (cyclopentyl)₂Si(OCH₃)², or of general formula

Si(OCH₂CH₃)₃(NR³R⁴)

wherein R³ and R⁴ can be the same or different a represent a hydrocarbon group having 1 to 12 carbon atoms.

R³ and R⁴ are independently selected from the group consisting of linear aliphatic hydrocarbon group having 1 to 12 carbon atoms, branched aliphatic hydrocarbon group having 1 to 12 carbon atoms and cyclic aliphatic hydrocarbon group having 1 to 12 carbon atoms. It is in particular preferred that R³ and R⁴ are independently selected from the group consisting of methyl, ethyl, n-propyl, n-butyl, octyl, decanyl, iso-propyl, iso-butyl, iso-pentyl, tert.-butyl, tert.-amyl, neopentyl, cyclopentyl, cyclohexyl, methylcyclopentyl and cycloheptyl.

More preferably, both R³ and R⁴ are the same, yet more preferably both R³ and R⁴ are an ethyl group.

Especially preferred external donors (ED) are the pentyl dimethoxy silane donor (D-donor) or the cyclohexylmethyl dimethoxy silane donor (C-Donor).

In addition to the Ziegler-Natta catalyst (ZN-C) and the optional external donor (ED) a co-catalyst can be used. The co-catalyst is preferably a compound of group 13 of the periodic table (IUPAC), e.g. organo aluminum, such as an aluminum compound, like aluminum alkyl, aluminum halide or aluminum alkyl halide compound. Accordingly, in one specific embodiment the co-catalyst (Co) is a trialkylaluminium, like triethylaluminium (TEAL), dialkyl aluminium chloride or alkyl aluminium dichloride or mixtures thereof. In one specific embodiment the co-catalyst (Co) is triethylaluminium (TEAL).

Advantageously, the triethyl aluminium (TEAL) has a hydride content, expressed as AlH₃, of less than 1.0 wt. % with respect to the triethyl aluminium (TEAL). More preferably, the hydride content is less than 0.5 wt. %, and most preferably the hydride content is less than 0.1 wt. %.

Preferably the ratio between the co-catalyst (Co) and the external donor (ED) [Co/ED] and/or the ratio between the co-catalyst (Co) and the transition metal (TM) [Co/TM] should be carefully chosen.

Accordingly, the mole ratio of co-catalyst (Co) to external donor (ED) [Co/ED] must be in the range of 5 to 45, preferably is in the range of 5 to 35, more preferably is in the range of 5 to 25; and optionally the mole ratio of co-catalyst (Co) to titanium compound (TC) [Co/TC] must be in the range of above 80 to 500, preferably is in the range of 100 to 350, still more preferably is in the range of 120 to 300.

The Ziegler-Natta catalyst (ZN-C) is preferably modified by the so-called BNT-technology during the above described pre-polymerization step in order to introduce the polymeric nucleating agent, preferably a vinyl compound. Details of such a modification can further be found in EP 1183307 and EP 3 184 587.

### Propylene Homopolymer (PP-H)

The propylene homopolymer (PP-H) according to the present invention is used in an amount of from 1 to 30 wt.-%, preferably from 5 to 20 wt.-%, based on the total weight of the polymer composition (C). Addition of propylene homopolymer (PP-H) allows the polymer composition (C) to have improved optical properties, as it allows the amorphous ethylene-propylene elastomer (EPR) to be dispersed within the crystalline matrix in fine particles, because of a favorable viscosity ratio between matrix (PP-H) and the dispersed amorphous ethylene-propylene elastomer (EPR)

The melt flow rate (MFR₂) of the propylene homopolymer (PP-H) as determined at 230° C. under a load of 2.16 kg in accordance with ISO 1133 is from 0.01 to 5.0 g/10 min, preferably from 0.01 to 3.0 g/10 min, more preferably from 0.1 to 1.0 g/10 min. Addition of the high molar mass (low MFR₂) PP-H also may act as nucleating agent during sheet extrusion, which decreases size of crystalline supramolecular structures (spherulites), further improving the transparency and optical quality.

The polypropylene homopolymer (PP-H) according to the present invention preferably has a pentad isotacticity (mmmm), as determined in accordance with 13C NMR analysis as described herein, of from 70 to 99%, more preferably from 85 to 95%.

It is particularly preferred when the polypropylene homopolymer (PP-H) according to the present invention has a melt flow rate (MFR₂) as determined at 230° C. under a load of 2.16 kg in accordance with ISO 1133, of from 0.01 to 3.0 g/10 min, more preferably of from 0.1 to 1.0 g/10 min and a pentad isotacticity (mmmm), as determined in accordance with ¹³C NMR analysis as described herein, of from 70 to 99%, more preferably from 85 to 95%.

### High Density Polyethylene (HDPE)

The high-density polyethylene (HDPE) according to the present invention is preferably used in an amount of from 0 to 20 wt.-%, more preferably from 2 to 10 wt.-%, based on the total weight of the polymer composition (C). In addition, the high-density polyethylene (HDPE) has a density of from 940 to 985 kg/m³, preferably of from 950 to 975 kg/m³.

It is also preferred that the high-density polyethylene (HDPE) is unimodal.

Preferably, the high density-polyethylene (HDPE) has a melt flow rate (MFR₂) as determined at 190° C. under a load of 2.16 kg in accordance with ISO 1133 ranging from 10 to 100 g/10 min, more preferably from 30 to 80 g/10 min.

The presence of the high-density polyethylene (HDPE) is preferred, because its addition on the one hand decreases the viscosity of the ethylene-propylene elastomer (EPR) and thereby allowing dispersion into fine particles and on the other hand, the high-density polyethylene (HDPE) increases the crystallinity of the ethylene-propylene elastomer (EPR), which also adds to the enhanced optical properties.

### Article

The present invention further relates to an article, preferably a film comprising the polymer composition (C) as mentioned herein. It is preferred that the article comprises the polymer composition (C) in an amount of at least 90 wt.-%, more preferably at least 95 wt.-% based on the total weight of the article. It is the most preferred that the article consists of the polymer composition (C).

The film may be a cast film or a blown film, while the cast film is more preferred. The film, more preferably the cast film may be a monolayer film or a single layer film within a structure of multilayer film.

The thickness of the film preferably ranges from 100 to 700 μm, more preferably from 200 to 500 μm.

It is preferred that the article, more preferably the film according to the present invention, has at least one or more, preferably all of the following properties:
a tensile modulus in machine direction, measured on 400 μm cast film in accordance with ISO 527-3, of from 200 to 1000 MPa, more preferably from 400 to 950 MPa,
a tensile modulus in transverse direction, measured on 400 μm cast film in accordance with ISO 527-3, of from 200 to 1000 MPa, more preferably from 400 to 850 MPa,
a haze, measured on 400 μm cast film in accordance with ASTM D1003-00, of from 5 to 40%, more preferably from 10 to 30%.

In other words, while the article, more preferably the film according to the present invention, may preferably have at least one or more of the properties as listed above, it is the most preferred when it has all the mentioned properties.

It is also preferred that the article, more preferably the film according to the present invention, has at least one or more, preferably all of the following properties:
an elongation at break in machine direction, measured on 400 μm cast film at 0° C. in accordance with ISO 527-3, of from 200 to 900%, more preferably from 300 to 750%,
an elongation at break in transverse direction, measured on 400 μm cast film at 0° C. in accordance with ISO 527-3, of from 200 to 850%, more preferably from 300 to 800%.

In other words, while the article, more preferably the film according to the present invention, may preferably have at least one or more of the properties as listed above, it is the most preferred when it has all the mentioned properties.

The present invention further relates to a use of the article, more preferably film disclosed herein in a packaging applications.

### Examples

### A. Measurement Methods

The properties of the polymers made in accordance with the present invention have been characterized according to the methods described herein, unless otherwise stated.

### Melt Flow Rate

The melt flow rate was measured as the MFR₂ in accordance with ISO 1133 (230° C., 2.16 kg load) for polypropylene and in accordance with ISO 1133 (190° C., 2.16 kg load) for polyethylene and is indicated in g/10 min. The MFR is an indication of the flowability, and hence the processability, of the polymer. The higher the melt flow rate, the lower the viscosity of the polymer.

The MFR₂ of a fraction (B) produced in the presence of a fraction (A) is calculated using the measured values of MFR₂ of fraction (A) and the mixture received after producing fraction (B) (“final”):

Log(MFR_{final})=weight fraction(A)*Log(MFR_{A})+weight fraction(B)*Log(MFR_{B}) (Equation 2)

### Density

Density was measured according to ISO1183. Sample preparation is done by compression moulding in accordance with ISO 1873.

### Crystex Analysis

### Crystalline and Soluble Fractions Method

The crystalline (CF) and soluble fractions (SF) of the heterophasic polypropylene-ethylene copolymers (HECO) as well as the comonomer content and intrinsic viscosities of the respective fractions were analyzed by use of the CRYSTEX instrument, Polymer Char (Valencia, Spain). Details of the technique and the method can be found in literature (Ljiljana Jeremic, Andreas Albrecht, Martina Sandholzer & Markus Gahleitner (2020) Rapid characterization of high-impact ethylene-propylene copolymer composition by crystallization extraction separation: comparability to standard separation methods, International Journal of Polymer Analysis and Characterization, 25:8, 581-596).

The crystalline and amorphous fractions were separated through temperature cycles of dissolution at 160° C., crystallization at 40° C. and re-dissolution in 1,2,4-trichlorobenzene at 160° C. Quantification of SF and CF and determination of ethylene content (C2) were achieved by means of an integrated infrared detector (IR4) and for the determination of the intrinsic viscosity (IV) an online 2-capillary viscometer was used.

The IR4 detector was a multiple wavelength detector measuring IR absorbance at two different bands (CH3 stretching vibration (centred at app. 2960 cm⁻¹) and the CH stretching vibration (2700-3000 cm⁻¹) that were serving for the determination of the concentration and the ethylene content in ethylene-propylene copolymers. The IR4 detector was calibrated with series of 8 EP copolymers with known ethylene content in the range of 2 wt.-% to 69 wt.-% (determined by ¹³C-NMR) and each at various concentrations, in the range of 2 and 13 mg/ml. To encounter for both features, concentration and ethylene content at the same time for various polymer concentrations expected during Crystex analyses the following calibration equations were applied:

Conc=a+b*Abs(CH)+c*(Abs(CH))²+d*Abs(CH₃)+e*(Abs(CH₃)²+f*Abs(CH)*Abs(CH₃) (Equation 3)

CH₃/1000C=a+b*Abs(CH)+c*Abs(CH₃)+d*(Abs(CH₃)/Abs(CH))+e*(Abs(CH₃)/Abs(CH))² (Equation 4)

The constants a to e for equation 3 and a to f for equation 4 were determined by using least square regression analysis.

The CH₃/1000C is converted to the ethylene content in wt.-% using following relationship:

Wt.-% (Ethylene in EP Copolymers)=100-CH₃/1000TC*0.3 (Equation 5)

Amounts of Soluble Fraction (SF) and Crystalline Fraction (CF) are correlated through the XS calibration to the “Xylene Cold Soluble” (XCS) quantity and respectively Xylene Cold Insoluble (XCI) fractions, determined according to standard gravimetric method as per ISO16152. XS calibration is achieved by testing various EP copolymers with XS content in the range 2-31 wt.-%. The determined XS calibration is linear:

Wt.-% XS=1,01*Wt.-% SF (Equation 6)

Intrinsic viscosity (IV) of the parent EP copolymer and its soluble and crystalline fractions were determined with a use of an online 2-capillary viscometer and are correlated to corresponding IV's determined by standard method in decalin according to ISO 1628-3. Calibration was achieved with various EP PP copolymers with IV=2-4 dL/g. The determined calibration curve is linear:

IV(dL/g)=a*Vsp/c (Equation 7)

The samples to be analyzed were weighed out in concentrations of 10 mg/ml to 20 mg/ml.

After automated filling of the vial with 1,2,4-TCB containing 250 mg/l 2,6-tert-butyl-4-methylphenol (BHT) as antioxidant, the sample was dissolved at 160° C. until complete dissolution was achieved, usually for 60 min, with constant stirring of 400 rpm. To avoid sample degradation, the polymer solution was blanketed with the N2 atmosphere during dissolution.

A defined volume of the sample solution was injected into the column filled with inert support where the crystallization of the sample and separation of the soluble fraction from the crystalline part was taking place. This process was repeated two times. During the first injection the whole sample was measured at high temperature, determining the IV [dl/g] and the C2 [wt. %] of the PP composition. During the second injection the soluble fraction (at low temperature) and the crystalline fraction (at high temperature) with the crystallization cycle were measured (wt.-% SF, wt.-% C2, IV).

### Quantification of Polypropylene Homopolymer Microstructure by NMR Spectroscopy

Quantitative nuclear-magnetic resonance (NMR) spectroscopy was used to quantify the isotacticity of the polypropylene homopolymers. Quantitative ¹³C{¹H} NMR spectra recorded in the solution-state using a Bruker Advance III 400 NMR spectrometer operating at 400.15 and 100.62 MHz for ¹H and ¹³C respectively. All spectra were recorded using a ¹³C optimised 10 mm selective excitation probehead at 125° C. using nitrogen gas for all pneumatics. Approximately 200 mg of material was dissolved in 1,2-tetrachloroethane-d₂ (TCE-d₂). This setup was chosen primarily for the high resolution needed for tacticity distribution quantification (Busico, V., Cipullo, R., Prog. Polym. Sci. 26 (2001) 443; Busico, V.; Cipullo, R., Monaco, G., Vacatello, M., Segre, A. L., Macromolecules 30 (1997) 6251). Standard single-pulse excitation was employed utilising the NOE and bi-level WALTZ16 decoupling scheme (Zhou, Z., Kuemmerle, R., Qiu, X., Redwine, D., Cong, R., Taha, A., Baugh, D. Winniford, B., J. Mag. Reson. 187 (2007) 225; Busico, V., Carbonniere, P., Cipullo, R., Pellecchia, R., Severn, J., Talarico, G., Macromol. Rapid Commun. 2007, 28, 11289). A total of 6144 (6k) transients were acquired per spectra using a 3 s recycle delay. Quantitative ¹³C{¹H} NMR spectra were processed, integrated and relevant quantitative properties determined from the integrals using proprietary computer programs. All chemical shifts are internally referenced to the methyl signal of the isotactic pentad mmmm at 21.85 ppm.

The tacticity distribution was quantified through integration of the methyl region between 23.6 and 19.7 ppm correcting for any sites not related to the stereo sequences of interest (Busico, V., Cipullo, R., Prog. Polym. Sci. 26 (2001) 443; Busico, V., Cipullo, R., Monaco, G., Vacatello, M., Segre, A. L., Macromolecules 30 (1997) 6251). The pentad isotacticity was determined through direct integration of the methyl region and reported as either the mole fraction or percentage of isotactic pentad mmmm with respect to all steric pentads i.e. [mmmm]=mmmm/sum of all steric pentads. When appropriate integrals were corrected for the presence of sites not directly associated with steric pentads.

### Notched Impact Strength (NIS)

The Charpy notched impact strength (NIS) was measured according to ISO 179 1eA at +23° C., 0° C. and −20° C. on 80×10×4 mm specimens (“Normstab B”).

### Haze

Haze was determined according to ASTM D1003-00 on 400 μm cast films obtained in accordance with the present invention.

### Tensile Properties

Tensile Modulus in both the machine (MD) and transverse (TD) directions as well as elongation in break in both machine (MD) and transverse (TD) directions were determined according to ISO 527-3 at 23° C. on 400 μm cast films obtained in accordance with the present invention. Testing was performed at a cross head speed of 1 mm/min up to the yield limit and at 10 mm/min up to specimen breakage.

### Atomic Force Microscopy

Specimens were prepared by cryocutting calendered films at −100° C. in transverse direction, in order to expose a cross section of the films. AFM micrographs were collected with an Oxford Instrument Cypher, operated in AMFM mode with Olympus AC160TS cantilevers. Free amplitude (first harmonic) was tuned at 1 V and images were taken with setpoint amplitude of 0.7 V. Pictures in the form of frequency images are herein reported.

### B. Examples

### Heterophasic Propylene-Ethylene Copolymer (HECO)

HECO as used in the examples was produced using a Ziegler-Natta catalyst as used in the inventive examples of WO 2016/066446 A1 and pre-polymerized with vinylcyclohexene to achieve nucleation with poly(vinylcyclohexene). Nucleation by prepolymerization with vinylcyclohexane is described in EP 2 960 256 B1 and EP 2 960 279 B1 in detail. Dicyclopentyl dimethoxy silane (donor D) was used as external donor and triethyl aluminium (TEAL) was used as co-catalyst.

The polymerization conditions are presented in Table 1 below.

TABLE 1
Polymerization conditions for HECO
Prepolymerization

| | | |
|---|---|---|
| TEAL/Ti ratio | mol/mol | 173 |
| TEAL/donor ratio | mol/mol | 8.0 |
| Temperature | [°C] | 30 |
| Pressure | [bar] | 53 |
| H2/C3 | [mol/kmol] | 0.10 |

Loop reactor

| | | |
|---|---|---|
| Temperature | [°C] | 80 |
| Split | [wt.-%] | 39 |
| H2/C3 | [mol/kmol] | 0.40 |
| MFR₂ | [g/10 min] | 2.4 |

1^{st} Gas phase reactor

| | | |
|---|---|---|
| Temperature | [°C] | 80 |
| Split | [wt.-%] | 50 |
| H2/C3 | [mol/kmol] | 7.0 |
| MFR₂ | [g/10 min] | 2.4 |

2^{nd} Gas phase reactor

| | | |
|---|---|---|
| Temperature | [°C] | 75 |
| Split | [wt.-%] | 11 |
| H2/C2 | [mol/kmol] | 223 |
| C2/C3 | [mol/kmol] | 551 |
| MFR₂ | [g/10 min] | 3.0 |

Final properties (pellet)

| | | |
|---|---|---|
| MFR₂ | [g/10 min] | 3.0 |
| SF | [wt.-%] | 13.9 |
| CF | [wt.-%] | 86.1 |
| C2(total) | [wt.-%] | 4.5 |
| C2(SF) | [wt.-%] | 28.1 |
| C2(CF) | [wt.-%] | 2.2 |
| iV(total) | [dL/g] | 2.60 |
| iV(SF) | [dL/g] | 1.67 |
| iV(CF) | [dL/g] | 2.70 |

The HECO was compounded with 1250 ppm of Calcium cis-1,2-cyclohexanedicarboxylate (Hyperform HPN-20E, supplied by Milliken, USA), 2000 ppm of Irganox 225 (1:1-blend of Pentaerythrityl-tetrakis(3-(3′,5′-di-tert.butyl-4-hydroxytoluyl)-propionate and tris(2,4-di-t-butylphenyl) phosphite), supplied by BASF AG, Germany, and 1000 ppm of calcium stearate, supplied by Croda, UK and the compounding was conducted in a co-rotating twin-screw extruder Coperion ZSK 47 at 220° C. The properties of the pellets given in Table 1 were measured on the compounded pellets.

### Propylene Homopolymer (PP-H)

The propylene homopolymer (PP-H) was polymerized in general agreement with EP2543684B1, which describes the diluent-slurry polymerization of high-isotactic polypropylene in five stirred-tank reactors using kerosene as the diluent. PP-H has a melt flow rate MFR₂ of 0.6 g/10 min (230° C., 2.16 kg) and concentration of isotactic pentads (mmmm) of 91% as determined by ¹³C NMR analysis.

### High-Density Polyethylene (HDPE)

HDPE as used in the examples was a unimodal polymer that was produced in a single loop reactor (preceded by pre-polymerization) using Lynx200 as catalyst (Ziegler-Natta catalyst supplied by Grace Catalyst Technologies). Polymerization conditions are presented in Table 2 below.

TABLE 2
Polymerization conditions for HDPE
Prepolymerization reactor

| | |
|---|---|
| Temperature [°C] | 60 |
| Pressure [bar] | 55 |
| C2 feed [kg/h] | 2 |
| H2 [g/h] | 5.0 |
| catalyst feed [g/h] | 2.0 |

Loop reactor

| | |
|---|---|
| Temperature [°C] | 95 |
| Pressure [bar] | 52 |
| H2/C2 ratio [mol/kmol] | 359.5 |
| Density [kg/m³] | 969.7 |
| MFR₂ [g/10 min] | 66 |

### Polymer Composition (C)

The polymer compositions (C) according to the inventive and comparative examples were prepared according to the recipes presented in Table 3, which also shows details of crystalline and soluble fractions of the composition (C).

TABLE 3
Recipes used for polymer compositions
(C) and details of CF and SF

| | | | |
|---|---|---|---|
| IE1 | IE2 | CE1 | CE2 |

Recipes

| | | | | | |
|---|---|---|---|---|---|
| HECO | [wt.-%] | 85 | 85 | 100 | 92.5 |
| PP-H | [wt.-%] | 15 | 7.5 | — | — |
| HDPE | [wt.-%] | — | 7.5 | — | 7.5 |

Details of CF and SF

| | | | | | |
|---|---|---|---|---|---|
| CF | [wt.-%] | 89.7 | 89.8 | 86.1 | 89.8 |
| SF | [wt.-%] | 10.3 | 10.2 | 13.9 | 10.2 |
| C2(total) | [wt.-%] | 3.7 | 11.5 | 4.5 | 18.7 |
| C2(SF) | [wt.-%] | 27.2 | 30.6 | 28.1 | 31.7 |
| C2(CF) | [wt.-%] | 1.7 | 9.7 | 2.2 | 18.1 |
| iV(total) | [dL/g] | 2.38 | 2.27 | 2.60 | 2.03 |
| iV(SF) | [dL/g] | 1.74 | 1.77 | 1.67 | 1.66 |
| iV(CF) | [dL/g] | 2.41 | 2.30 | 2.70 | 2.03 |

Cast films having 400 μm thickness were produced from the polymer compositions (C) as presented in Table 3, on a Collin lab scale cast film line, with a melt temperature of 250° C., chill temperature of 60° C. and output rate of 8 kg/h.

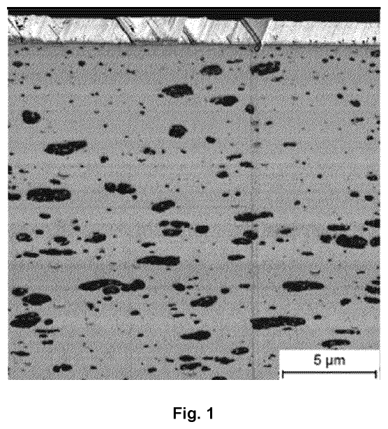

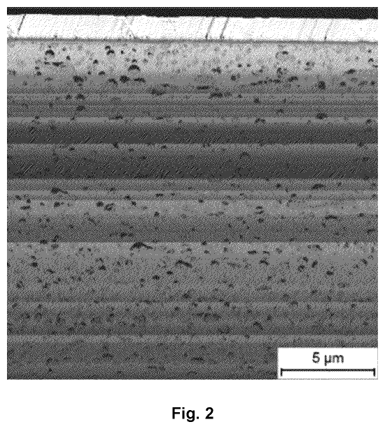

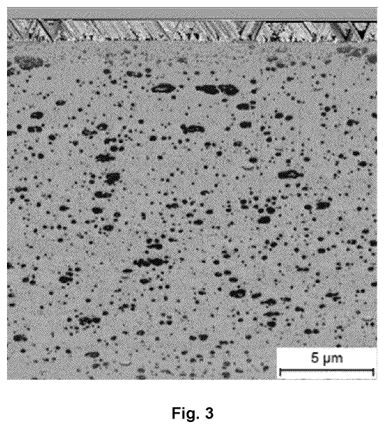

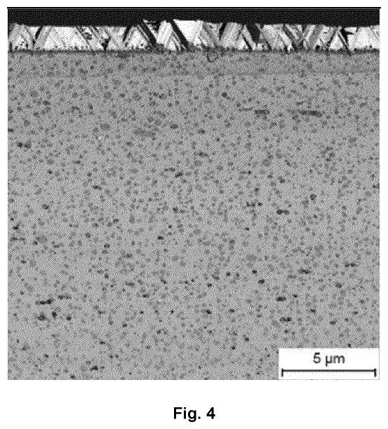

The morphology of the cast films made of inventive and comparative examples have been analysed using AFM, as provided in FIGS. 1-4. FIG. 1 shows the image of films made on CE1, FIG. 2 shows CE2, FIG. 3 shows IE1 and FIG. 4 shows IE2. As can be seen in FIG. 3, addition of PP-H has resulted in the particles of EPR to be dispersed into smaller particles. When HDPE is also added to the polymer composition (C), the EPR particle size is even more decreased. As a result, improved optics were obtained for IE1 and IE2, which can be seen in Table 4.

Some other properties of the cast films prepared using the polymer compositions (C) according to the present invention is presented in Table 4.

TABLE 4
Performance of the final examples

| | | IE1 | IE2 | CE1 | CE2 |
|---|---|---|---|---|---|
| NIS (23 °C.)* | [kJ/m²] | 36.94 | 35.37 | 33.6 | 12.76 |
| NIS (0 °C.)* | [kJ/m²] | 2.03 | 2.71 | 1.96 | 2.91 |
| NIS (−20 °C.)* | [kJ/m²] | 0.96 | 0.97 | 0.95 | 0.96 |
| Haze** | [%] | 28.38 | 20.47 | 43.88 | 34.35 |
| Tensile Modulus (MD)** | [MPa] | 868 | 868 | 989 | 883 |
| Tensile Modulus (TD)** | [MPa] | 790 | 780 | 986 | 776 |
| Elongation at | [%] | 637 | 616 | 872 | 665 |
| break (MD)** | | | | | |
| Elongation at | [%] | 787 | 659 | 854 | 14 |
| break (TD)** | | | | | |

*measured on 80 × 10 × 4 mm specimens,
**measured on 400 μm cast films

It is evident from Table 4 that cast films made of IE1 and IE2 exhibit an improved impact strength at 23° C. compared to both CE1 and in particular compared to CE2, as an effect of the morphology and (limited or no) amount of HDPE in IE1 and IE2 compared to CE2Too much HDPE makes the material too brittle, because the chemical and physical difference between the polypropylene homopolymer matrix and the ethylene-propylene elastomer particles become too large. For the same reasons, both IE1 and IE2 exhibit an improved impact strength at 0° C. compared to CE1, while IE2 exhibits an improved impact strength at −20° C. compared to both CE1 and CE2. Furthermore, optical properties of the films in terms of haze appears to be improved for IE1 and IE2, because the tensile properties are also at an acceptable level for IE1 and IE2, as a result of the fine dispersion of the ethylene-propylene elastomer phase.

1. A polymer composition (C) comprising:
a) a heterophasic propylene-ethylene copolymer (HECO) having a melt flow rate (MFR₂) as determined at 230° C. under a load of 2.16 kg in accordance with ISO 1133 of from 0.1 to 15.0 g/10 min, in an amount of from 50 to 99 wt. % based on the total weight of the polymer composition (C), comprising:
a1) a crystalline matrix that is a propylene homopolymer or a copolymer of propylene and ethylene and/or C₃-C₁₂ alpha olefins;
a2) an amorphous propylene-ethylene elastomer (EPR);
wherein the heterophasic propylene-ethylene copolymer (HECO) is further characterized by its crystalline fraction (CF) and soluble fraction (SF) as determined by CRYSTEX QC analysis, wherein the soluble fraction (SF) has an ethylene content of from 10 to 50 wt. % based on the total weight of the soluble fraction (SF);
b) a propylene homopolymer (PP-H) having a melt flow rate (MFR₂) as determined at 230° C. under a load of 2.16 kg in accordance with ISO 1133 of from 0.01 to 5.0 g/10 min, in an amount of from 1 to 30 wt. % based on the total weight of the polymer composition (C); and
c) optionally, a high-density polyethylene (HDPE) with a density of from 940 to 985 kg/m³, in an amount of from 0 to 20 wt. % based on the total weight of the polymer composition (C).

2. The polymer composition (C) according to claim 1, wherein the heterophasic propylene-ethylene copolymer (HECO) is present in an amount of from 60 to 90 wt. % based on the total weight of the polymer composition (C).

3. The polymer composition (C) according to claim 1, wherein the heterophasic propylene-ethylene copolymer (HECO) has a melt flow rate (MFR₂) as determined at 230° C. under a load of 2.16 kg in accordance with ISO 1133 of from 0.5 to 10.0 g/10 min.

4. The polymer composition (C) according to claim 1, wherein the crystalline matrix of the heterophasic propylene-ethylene copolymer (HECO) is a homopolymer of propylene.

5. The polymer composition (C) according to claim 1, wherein the heterophasic propylene-ethylene copolymer (HECO) has at least one or more of the following properties according to CRYSTEX OC analysis:
a crystalline fraction (CF) in an amount of from 70 to 95 wt. % and a soluble fraction (SF) in an amount from 5 to 30 wt. %, based on the total weight of the heterophasic propylene-ethylene copolymer (H-ECO);
a total ethylene (C2) content of from 0.5 to 25 wt. %;
an ethylene (C2) content of crystalline fraction (CF) of from 0.5 to 25 wt. %;
an ethylene (C2) content of soluble fraction (SF) of from 20 to 40 wt. %;
an intrinsic viscosity (IV) of crystalline fraction (CF), determined in accordance with DIN ISO 1628/1 (in Decalin 135° C.), of from 1.0 to 10.0 dUg;
an intrinsic viscosity (IV) of soluble fraction (SF), determined in accordance with DIN ISO 1628/1 (in Decalin 135° C.), of from 0.5 to 10.0 dUg.

6. The polymer composition (C) according to claim 1, wherein the propylene homopolymer (PP-H) is in an amount of from 5 to 20 wt. % based on the total weight of the polymer composition (C).

7. The polymer composition (C) according to claim 1, wherein the
propylene homopolymer (PP-H) has:
a melt flow rate (MFR₂) as determined at 230° C. under a load of 2.16 kg in accordance with ISO 1133 of from 0.01 to 3.0 g/10 min; and/or
a pentad isotacticity (mmmm), as determined in accordance with ¹³C NMR analysis as described herein, of from 70 to 99%.

8. The polymer composition (C) according to claim 1, wherein the high density polyethylene (HDPE) is unimodal.

9. The polymer composition (C) according to claim 1, wherein the high density polyethylene (HDPE) is present in an amount of from 2 to 10 wt. %.

10. The polymer composition (C) according to claim 1, wherein the high density polyethylene (HDPE) has a melt flow rate (MFR₂) as determined at 190° C. under a load of 2.16 kg in accordance with ISO 1133 of from 10 to 100 g/10 min.

11. The polymer composition (C) according to claim 1, wherein the high-density polyethylene (HDPE) has a density of from 950 to 975 kg/m³.

12. The polymer composition (C) according to claim 1 having at least one or more of the following properties:
a tensile modulus in machine direction, measured on 400 μm cast film in accordance with ISO 527-3, of from 200 to 1000 MPa,
a tensile modulus in transverse direction, measured on 400 μm cast film in accordance with ISO 527-3, of from 200 to 1000 MPa,
a haze, measured on 400 μm cast film in accordance with ASTM D1003-00, of from 5 to 40%.

13. The polymer composition (C) according to claim 1 having at least one or more of the following properties:
a Charpy Notched Impact Strength (NIS), measured on 80×10×4 mm specimens at 23° C. in accordance with ISO 179 1eA, of from 15 to 70 kJ/m²;
a Charpy Notched Impact Strength (NIS), measured on 80×10×4 mm specimens at 0° C. in accordance with ISO 1791eA, of from 1 to 10 kJ/m²;
an elongation at break in machine direction, measured on 400 μm cast film at 0° C. in accordance with ISO 527-3, of from 200 to 900%;
an elongation at break in transverse direction, measured on 400 μm cast film at 0° C. in accordance with ISO 527-3, of from 200 to 850%.

14. An article comprising the polymer composition (C) according to claim 1.

15. The article according to claim 14, configured for packaging applications.
